(19) United States
(12) Patent Application Publication
(10) Pub. No.: US 2006/0263460 A1
(43) Pub. Date: Nov. 23, 2006

(54) Jig structure for manufacturing an image sensor

(76) Inventor: Chief Lin, Hsinchu Hsien (TW)

Correspondence Address: PRO-TECHTOR INTERNATIONAL SERVICES, 20775 NORADA CT., SARATOGA, CA, 95070, US

(21) Appl. No.: 11/131,728

(22) Filed: May 18, 2005

(51) Int. Cl. A23G 1/22

(52) U.S. Cl. 425/117; 425/110

(57) ABSTRACT

A jig structure for manufacturing an image sensor, the image sensor includes a substrate and a frame layer, wherein the jig is located on the substrate, then fill the filler in the jig to form the frame layer, the jig comprising a plurality of connection channel to produce a plurality of square shape, dummy channel, and at least a inlet connected the channel and the dummy channel, so that fill the filler into the channel to form the frame layer of the image sensor.

### BACKGROUND OF THE INVENTION

1. Field of the Invention

The invention relates to a jig structure for manufacturing an image sensor, and particular to a jig structure for forming a frame layer on the substrate of the image sensor, the reliability of the image sensor may be promoted.

2. Description of the Related Art

Referring to FIG. 1, it is an image sensor structure includes a substrate 10, a frame layer 18, a photosensitive chip 26, a plurality of wires 28, and a transparent layer 34.

The substrate 10 has a first surface 12 on which plurality of first electrodes 15 are formed, and a second surface 14 on which plurality of second electrodes 16 are formed. The first electrodes 15 are corresponding to electrically connect to the second electrodes 16 by the conductive wires 17, which are located at the side of the substrate. The frame layer 18 has an upper surface 20 and a lower surface 22 adhered to the first surface 12 of the substrate 10 to form a chamber 24 together with the substrate 10. The photosensitive chip 26 is arranged within the chamber 24, and is mounted to the first surface 12 of the substrate 10. Each wire 28 has a first terminal 30 and a second terminal 32. The first terminals 30 are electrically connected to the photosensitive chip 26, and the second terminals 32 are electrically connected to the first electrodes 15 of the substrate 10. The transparent layer 34 is adhered to the upper surface 20 of the frame layer 18.

Please Referring to FIG. 2, it is a jig structure for manufacturing an image sensor. Firstly, providing a conventional jig 34 on the substrate 10 of the image sensor, the jig includes a plurality of connection channel 36 to produce a plurality of square shape 38 and at least a inlet 40 is connected the connection channel 36, so that fill the filler into the channel 36 to form the frame layer 18 on the substrate 10 of the image sensor.

The conventional jig structure for manufacturing an image sensor has the following drawback.

Since the air from the connection channel 36 is filled within the frame, so that reliability of the image sensor is poor.

### SUMMARY OF THE INVENTION

An objective of the invention is to provide a jig structure for manufacturing an image sensor capable of increasing the reliability of the image sensor.

To achieve the above-mentioned object, the invention provides a jig that comprise a plurality of connection channel to produce a plurality of square shape, dummy channel, and at least a inlet connected the channel and the dummy channel, so that fill the filler into the channel to form the frame layer of the image sensor, the air from the channel may be pushed in the dummy channel, so that the reliable of the image sensor may be promoted.

### BRIEF DESCRIPTION OF THE DRAWINGS

FIG. 1 is a schematic illustration showing an image sensor structure.

FIG. 2 is a conventional jig structure for manufacturing an image sensor.

FIG. 3 is a schematic illustration showing a jig structure for manufacturing an image sensor of the present invention.

FIG. 4 is a schematic illustration showing a frame layer on the substrate of the image sensor.

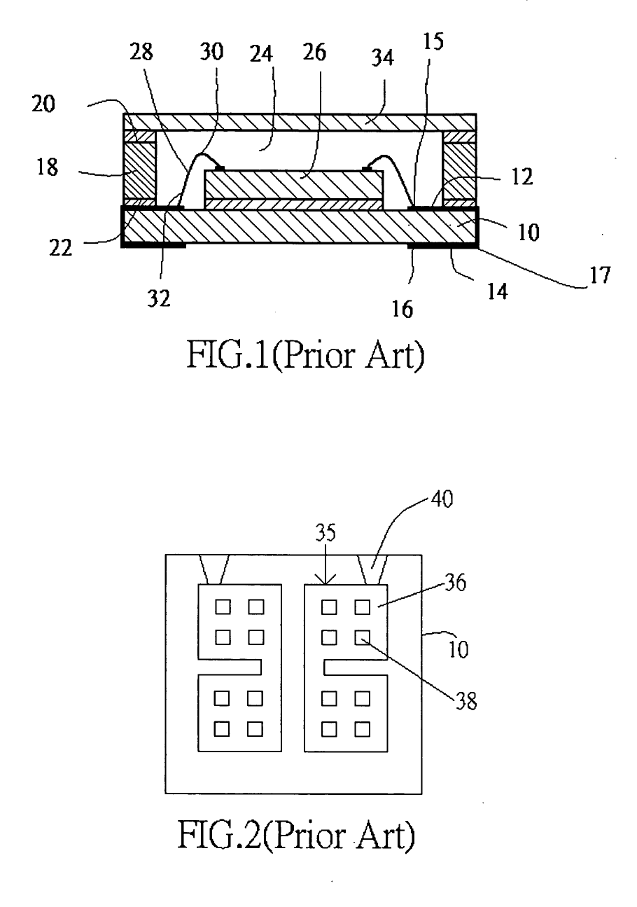

### DETAILED DESCRIPTION OF THE INVENTION

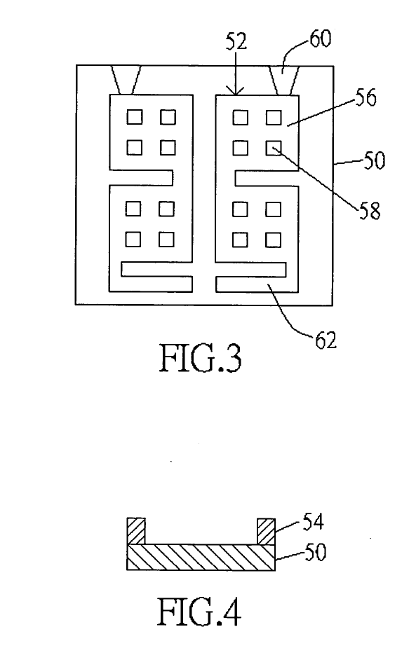

Please refer to FIG. 3, a jig structure for manufacturing an image sensor of the present invention includes a plurality of connection channel 56, dummy channel 62, and inlet 60.

The jig structure includes a plurality of connection channel 56 to form square shape 58, dummy channel 62, and inlet 60 connected the connection channel 56 and dummy channel 62.

The jig is mounted on a substrate 50 of an image sensor, then, providing filler filled in the connection channel 62 through the inlet 60 to form a frame layer 54, therefore, the air from the connection channel 56 is pushed to the dummy channel 62, so that the reliability of the image sensor may be promoted.

In the embodiment, the filler is plastic material is form of compound.

While the invention has been described by the way of an example and in terms of a preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

What is claimed is:

1. A jig structure for manufacturing an image sensor, the image sensor includes a substrate and a frame layer, wherein the jig is located on the substrate, then fill the filler in the jig to form the frame layer, the jig comprising a plurality of connection channel to produce a plurality of square shape, dummy channel, and at least a inlet connected the channel and the dummy channel, so that fill the filler into the channel to form the frame layer of the image sensor.

2. The jig structure for manufacturing an image sensor according to claim 1, wherein the filler is plastic material.

3. The jig structure for manufacturing an image sensor according to claim 2, wherein the plastic material is made of compound.
